(19) United States
(12) Patent Application Publication
(10) Pub. No.: US 2021/0322930 A1
(43) Pub. Date: Oct. 21, 2021

(54) ZWITTERIONIC POLYELECTROLYTE COATED FILTRATION MEDIUM FOR SLOP WATER TREATMENT

(71) Applicant: Halliburton Energy Services, Inc., Houston, TX (US)

(72) Inventors: William Cecil Pearl, JR., Spring, TX (US); William Walter Shumway, Spring, TX (US); Dale E. Jamison, Humble, TX (US)

(21) Appl. No.: 16/854,700

(22) Filed: Apr. 21, 2020

(51) Int. Cl. B01D 69/02; B01D 71/40; B01D 71/02; B01D 61/58; B01D 21/00; B01D 65/02; C02F 1/44; C02F 1/24; C02F 1/38; C02F 1/00; B01D 21/26

(52) U.S. Cl. CPC B01D 69/02; C02F 2103/10; B01D 71/024; B01D 61/58; B01D 21/0084; B01D 65/02; C02F 1/44; C02F 1/24; C02F 1/38; C02F 1/004; B01D 21/262; B01D 2325/18; B01D 2311/2649; B01D 2311/2676; B01D 2311/2665; B01D 71/40

(57) ABSTRACT

Systems and methods for using a filtration medium coated with a zwitterionic polyelectrolyte to treat slop water recovered. In some embodiments, the systems include: a treatment unit including an inlet for receiving a slop water stream into the treatment unit, a first filtration medium including a porous substrate at least partially coated with a zwitterionic polyelectrolyte, wherein the first filtration medium is disposed to separate a first portion of the slop water stream in the treatment unit from a second portion of the slop water stream in the treatment unit, wherein the first portion of the slop water stream includes water, a first outlet on a first side of the first filtration medium, and a second outlet on a second side of the first filtration medium opposite the first side.

### BACKGROUND

The present disclosure relates to systems and methods for treating fluids recovered in wellbore operations.

Treatment fluids may be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid.

Hydrocarbons, such as oil and gas, are commonly obtained from subterranean formations that may be located onshore or offshore. The development of subterranean operations and the processes involved in removing hydrocarbons from a subterranean formation typically involve a number of different steps such as, for example, drilling a wellbore at a desired well site, treating the wellbore to optimize production of hydrocarbons, and performing the necessary steps to produce and process the hydrocarbons from the subterranean formation.

Throughout these various subterranean operations, including drilling, completions, well treatment operations, and production, fluids are cycled through the downhole system and recovered at the surface of the well. Some of the fluids recovered at the surface may constitute “slop water,” a liquid waste that is a mixture of mostly water with significant concentrations of oil and drilling mud. Obtaining and later disposing of the process fluids, such as slop water, can sometimes increase costs of certain operations.

### BRIEF DESCRIPTION OF THE DRAWINGS

These drawings illustrate certain aspects of some of the embodiments of the present disclosure and should not be used to limit or define the claims.

FIG. 1 is a cross-sectional schematic view of a treatment unit with a flat filtration medium coated with a zwitterionic polyelectrolyte in accordance with certain embodiments of the present disclosure.

FIG. 2 is a cross-sectional schematic view of a treatment unit with a cylindrical filtration medium coated with a zwitterionic polyelectrolyte in accordance with certain embodiments of the present disclosure.

FIG. 3 is a perspective schematic view of a treatment unit with a tubular filtration medium coated with a zwitterionic polyelectrolyte in accordance with certain embodiments of the present disclosure.

FIG. 4 is a partial cutaway schematic view of a treatment unit with a fiber bundle filtration medium coated with a zwitterionic polyelectrolyte in accordance with certain embodiments of the present disclosure.

FIG. 5 is a partial cutaway schematic view of a treatment unit with a sand pack filtration medium coated with a zwitterionic polyelectrolyte in accordance with certain embodiments of the present disclosure.

FIG. 6 is a cross-sectional schematic view of a treatment unit consisting of two filtration mediums in accordance with certain embodiments of the present disclosure.

FIG. 7 is a diagram illustrating an example of a treatment system treating slop water in accordance with certain embodiments of the present disclosure.

FIG. 8 is a diagram illustrating another example of a treatment system treating slop water in accordance with certain embodiments of the present disclosure.

FIG. 9 is a diagram illustrating an example of a wellbore drilling assembly that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will be recognizable to those skilled in the pertinent art and having the benefit of this disclosure. The depicted and described embodiments of this disclosure are examples only and not exhaustive of the scope of the disclosure.

### DESCRIPTION OF CERTAIN EMBODIMENTS

The present disclosure relates to systems and methods for treating fluids recovered in wellbore operations. More particularly, the present disclosure relates to systems and methods for using a filtration medium coated with a zwitterionic polyelectrolyte to treat slop water recovered at an offshore rig site.

In management of slop water on an offshore rig location, it may be desirable to clean slop water recovered from the well and other locations at the rig site so that the water can be discharged directly from the rig site. The slop water may contain water with varying concentrations of oil and drilling mud. Management of slop water at an offshore rig site may be costly, for example, where slop water is transported to shore in large vessels for treatment and disposal. In addition to high transportation costs, the process of shipping the slop water to shore for treatment can lead to inefficiencies and risks associated with the logistics of transport. The present disclosure provides certain systems and methods to remove contaminants from slop water at the offshore rig site so that the resulting water may be disposed by other means.

The present disclosure provides a treatment unit for use in treatment of slop water recovered in wellbore operations. The treatment unit may include a filtration medium having a porous substrate at least partially coated with a zwitterionic polyelectrolyte. The filtration medium may separate water from other components within a fluid stream. The treatment unit may include an inlet to receive a fluid stream into the treatment unit. The fluid stream may be pretreated prior to reaching the treatment unit. The treatment unit may also include a first outlet in fluid communication with one side of the filtration medium and a second outlet in fluid communication with the opposite side of the filtration medium.

The fluid treatment systems and methods described herein may utilize a filtration medium having a polymeric, a ceramic, a metal, or other porous substrate that may be coated with a zwitterionic polyelectrolyte. The zwitterionic polyelectrolyte coating is hydrophilic and oleophobic. Thus, the natural tendency is for water to migrate through the filtration medium with little or no differential pressure applied to the filtration medium itself. As a result, the zwitterionic polyelectrolyte coated filtration medium may draw water across the filtration medium while discouraging or preventing oil and contaminants from moving across the filtration medium.

Among the many potential advantages to the systems and methods of the present disclosure, only some of which are alluded to herein, the systems and methods of the present disclosure may provide improved treatment of fluids recovered from wells, inter alia, because the treatment units disclosed herein may facilitate separating water from other fluids and contaminants than certain other filtration mediums known in the art. In one or more embodiments, the systems and methods of the present disclosure may include using a zwitterionic polyelectrolyte coated filtration medium to separate clean water from the slop water, thereby facilitating disposal of the clean water or reuse of the clean water in pit washing operations. For example, recovered slop water may be treated via the treatment unit to provide potable water. The amount of water that may be reused for other purposes may be greater than the amount of water that could otherwise be reused without the zwitterionic polyelectrolyte coated treatment unit. As such, the disclosed treatment units may decrease the costs associated with the disposal of slop water and other fluids used within an oil and gas well and allow for increased reuse of the fluids.

In certain embodiments, the treatment unit in the disclosed fluid treatment systems and methods may include a treatment unit having a porous substrate at least partially coated with a zwitterionic polyelectrolyte. As used herein, the term “zwitterionic polyelectrolyte” refers to a polymer containing both negative and positive charges within the same monomers. As used herein, unless the context otherwise requires, a “polymer” or “polymeric material” includes oligomers, homopolymers, copolymers, terpolymers, etc. The zwitterionic polyelectrolytes of the present disclosure may include any zwitterionic polyelectrolyte known in the art, and in some embodiments may be classified into sulfobetaine, carboxybetaine, and phosphorylcholine groups depending upon the present anionic moiety. Examples of zwitterionic polyelectrolytes that may be suitable for certain embodiments of the present disclosure include, but are not limited to, poly(2-methacryloyloxyethyl phosphorylcholine) (PMPC), poly(sulfobetaine methacrylate) (PSBMA), poly(sulfobetaineacrylamide) (PSBAAm), poly(carboxybetaine methacrylate) (PCBMA), poly(carboxybetaine acrylamide) (PCBAA), poly[oligo(ethyleneglycol) methacrylate] (POEGMA), poly (3-(1-(4-vinylbenzyl)-1H-imidazol-3-ium-3-yl)propane-1-sulfonate) (PVBIPS), and any combination thereof. In some embodiments, the treatment unit of the present disclosure may be at least partially coated with PMPC. PMPC may contain repeated monomeric units composed of a phosphorylcholine group, which may provide superior hydrophilic and oleophobic properties compared to other zwitterionic polyelectrolytes. In some embodiments, a filtration medium at least partially coated with a zwitterionic polyelectrolyte may increase the water-binding affinity of the filtration medium. In certain embodiments, a filtration medium at least partially coated with a zwitterionic polyelectrolyte may enhance the oil repellency of the filtration medium in a water-wetted state. In some embodiments, a filtration medium at least partially coated with a zwitterionic polyelectrolyte may enhance the oil repellency of the filtration medium in a dry state. In some embodiments, a filtration medium at least partially coated with a zwitterionic polyelectrolyte may enhance the resiliency of the filtration medium toward oil-contamination. In other embodiments, a filtration medium at least partially coated with a zwitterionic polyelectrolyte may provide self-cleaning of the filtration medium, wherein oil fouled on the filtration medium in a dry state is displaced upon contact with water.

In certain embodiments, the treatment unit used in the disclosed fluid treatment systems and methods may include a cross flow filtration medium. That is, the treatment unit may be arranged with one inlet and at least two outlets. The inlet of the treatment unit may receive a feed in the form of an incoming fluid stream, and a first outlet of the treatment unit may output a filtrate while a second outlet of the filtration medium may output a retentate (or concentrate). In this manner, the incoming fluid stream may flow over the filtration medium without solids in the fluid stream packing off against the filtration medium. As described above, in certain embodiments, the treatment unit may exhibit one or more hydrophilic properties, in which the filtrate output from the first inlet of the treatment unit may include water. In some embodiments, the filtrate may be substantially entirely water. The filtrate may include water with less than about 2000 parts per million (“ppm”) of remaining contaminants, or alternatively, less than about 1000 ppm of remaining contaminants, or alternatively, less than about 500 ppm of remaining contaminants. In other embodiments, the treatment unit may exhibit one or more hydrophobic properties, in which the filtrate output from the first inlet of the treatment unit may include oil. In some embodiments, the filtrate may be substantially entirely oil. The filtrate may include oil with less than about 2000 ppm of remaining contaminants, or alternatively, less than about 1000 ppm of remaining contaminants, or alternatively, less than about 500 ppm of remaining contaminants.

In some embodiments, the disclosed treatment unit may include only a single filtration medium over which the fluid stream may flow. In other embodiments, the treatment unit may feature multiple filtration mediums over which the fluid stream may flow. The treatment unit may function as a passive filtration medium through which the fluid stream may be separated over time into permeate and retentate. In certain embodiments, the fluid stream may be a slop water stream. In some embodiments, the treatment unit may include a stirring or agitation device disposed in the treatment unit to stir the fluid located therein, among other reasons, to reduce or eliminate any filter cake forming across the filtration medium over time. In certain embodiments, it may be desirable to flow the fluid stream through the treatment unit via a pump to maintain a differential pressure across the filtration medium to encourage separation of the permeate from the retentate. The pump may maintain a pressure differential across the filtration medium within a range of approximately 1 to 100 pounds per square inch (“psi”), or alternatively, approximately 1 to 25 psi, or alternatively, approximately 1 to 10 psi. In some embodiments, the pump may be in fluid communication with the inlet of the treatment unit and with the second outlet of the treatment unit such that the pump is able to continuously cycle the retentate (or a portion thereof) back through the treatment unit. In certain embodiments, the filtration medium may be cycled through a system that continually cleans and renews the surface of the filtration medium. Still other arrangements of the treatment unit will be apparent to those of ordinary skill in the art.

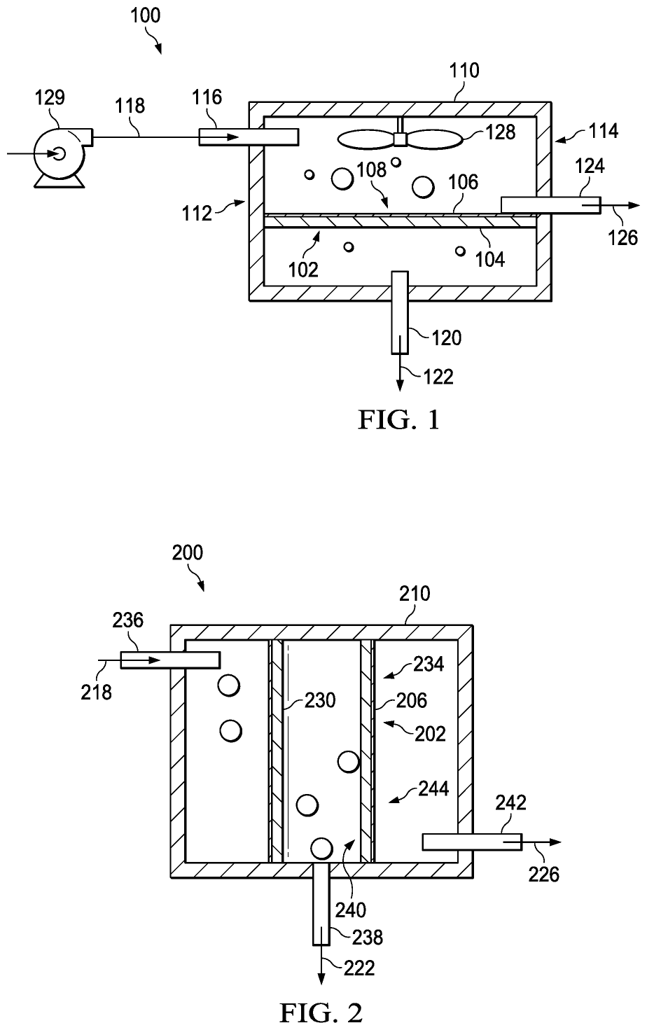

The disclosed treatment unit may include any desired shape or arrangement of the zwitterionic polyelectrolyte coated filtration medium disposed therein. For example, the filtration medium may take the form of one or more flat sheets. FIG. 1 illustrates a treatment unit 100 having a housing 110 and a filtration medium 102 disposed in the housing 110. The filtration medium 102 may include a substrate 104 in the form of a porous flat sheet. The flat sheet may include a zwitterionic polyelectrolyte 106 coated on one planar side 108 of the porous substrate 104, this side 108 facing toward an input fluid stream 118 flowing within the treatment unit 100. In an embodiment, the filtration medium 102 may include a flat sheet extending from one end 112 of the treatment unit 100 to an opposite end 114 of the treatment unit 100. In another embodiment (not shown), the treatment unit may include multiple flat sheet filtration mediums disposed at different positions along a main flow path for the fluid stream flowing through the treatment unit. The treatment unit 100 of FIG. 1 may include an inlet 116 to receive the input fluid stream 118 into the treatment unit 100, a first outlet 120 in fluid communication with one side (opposite the zwitterionic polyelectrolyte coating 106) of the filtration medium 102 to output a permeate 122, and a second outlet 124 in fluid communication with the opposite side (facing the zwitterionic polyelectrolyte coating 106) of the filtration medium 102 to output a retentate 126. The treatment unit 100 may include a stirring or agitation device 128 disposed in the treatment unit 100 on a side of the filtration medium 102 facing the zwitterionic polyelectrolyte coating 106. The stirring or agitation device 128 may stir the fluid located in the treatment unit 100 so that no filter cake forms across the filtration medium 102 over time. In addition, the stirring or agitation device 128 may generate a relatively low pressure differential across the filtration medium 102. The treatment unit 100 may receive the input fluid stream 118 through the inlet 116 under a desired amount of pressure from a pump 129 in fluid communication with the inlet 116, and this pressure may provide a relatively low pressure differential across the filtration medium 102. Keeping the pressure differential within a range of approximately 1 to 25 psi, or alternatively, approximately 1 to 10 psi may enable the treatment unit 100 to function as a passive filtration medium.

The filtration medium may take the form of one or more cylindrical sheets. FIG. 2 illustrates a treatment unit 200 having a housing 210 and a filtration medium 202 disposed in the housing 210. The filtration medium 202 may include a substrate 230 in the form of a porous sheet wrapped into a cylinder shape. The cylindrical filtration medium 202 may include the zwitterionic polyelectrolyte coating 206 on a radially outward facing side 234 of the porous substrate 230, taken with respect to an axis about which the substrate 230 is wrapped. In some embodiments, the substrate 230 may be wrapped once such that the filtration medium 202 forms a single cylindrical shape. In another embodiment (not shown), the substrate 230 may be wrapped multiple times in a spiral fashion around itself to provide multiple layers through which water permeates before exiting the treatment unit 200. The treatment unit 200 of FIG. 2 may include an inlet 236 to receive the input fluid stream 218 into the treatment unit 200, a first outlet 238 in fluid communication with a radially inner side 240 (opposite the zwitterionic polyelectrolyte coating 206) of the filtration medium 202 to output the permeate 222, and a second outlet 242 in fluid communication with a radially outer side 244 (facing the zwitterionic polyelectrolyte coating 206) of the filtration medium 202 to output the retentate 226. Although not illustrated, the treatment unit 200 of FIG. 2 may include a stirring or agitation device similar to FIG. 2 on the radially outer side 244 of the filtration medium 202.

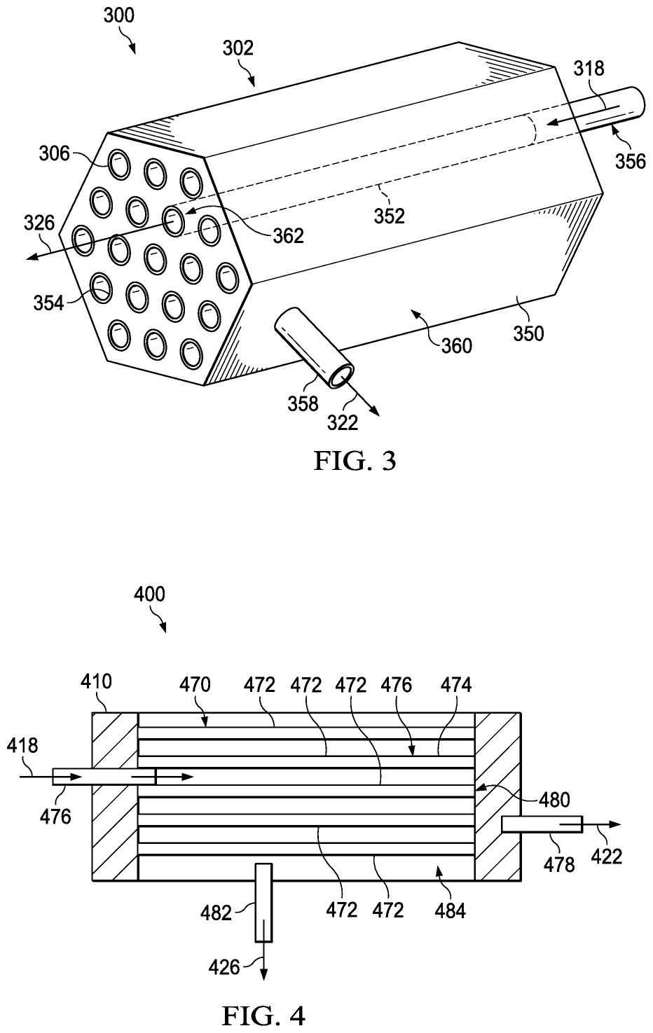

The filtration medium may take the form of a material having tubular shaped pathways extending therethrough, wherein the fluid stream flows through the pathways. FIG. 3 illustrates a treatment unit 300 having a filtration medium 302 with a substrate 350 in the form of a material with tubular pathways 352 formed therethrough. The zwitterionic polyelectrolyte 306 may be coated on a radially inner surface 354 of each of the tubular shaped pathways 352 within the filtration medium substrate 350. The treatment unit 300 of FIG. 3 may include an inlet 356 to receive the input fluid stream 318 into the treatment unit 300, a first outlet 358 in fluid communication with an external side 360 (opposite the zwitterionic polyelectrolyte coating 306) of the filtration medium 302 to output the permeate 322, and a second outlet 362 in fluid communication with the inside of the tubular pathways 352 (facing the zwitterionic polyelectrolyte coating 306) of the filtration medium 302 to output the retentate 326. A pump coupled in fluid communication to the substrate 350 may provide backpressure through the tubular pathways 352.

The filtration medium may take the form of a bundle of fibers arranged within a pressure chamber where the fluid stream flows through a space surrounding the fibers and the permeate exits through the fiber ends. FIG. 4 illustrates a treatment unit 400 having a filtration medium 402 with a substrate 470 in the form of a bundle of porous fibers 472. In such instances, the zwitterionic polyelectrolyte 406 may be coated on a radially external surface 474 of each of the porous fibers 472. The treatment unit 400 of FIG. 4 may include an inlet 476 to receive the input fluid stream 418 into the treatment unit 400, a first outlet 478 in fluid communication with an end 480 of the one or more porous fibers 472 (opposite the zwitterionic polyelectrolyte coating 406) of the filtration medium 402 to output the permeate 422, and a second outlet 482 in fluid communication with a radially external side 484 (facing the zwitterionic polyelectrolyte coating 406) of the filtration medium 402 to output the retentate 426. Although not illustrated, the treatment unit 400 of FIG. 4 may include a stirring or agitation device similar to FIG. 4 located external to the porous fibers 472 to keep the boundary refreshed.

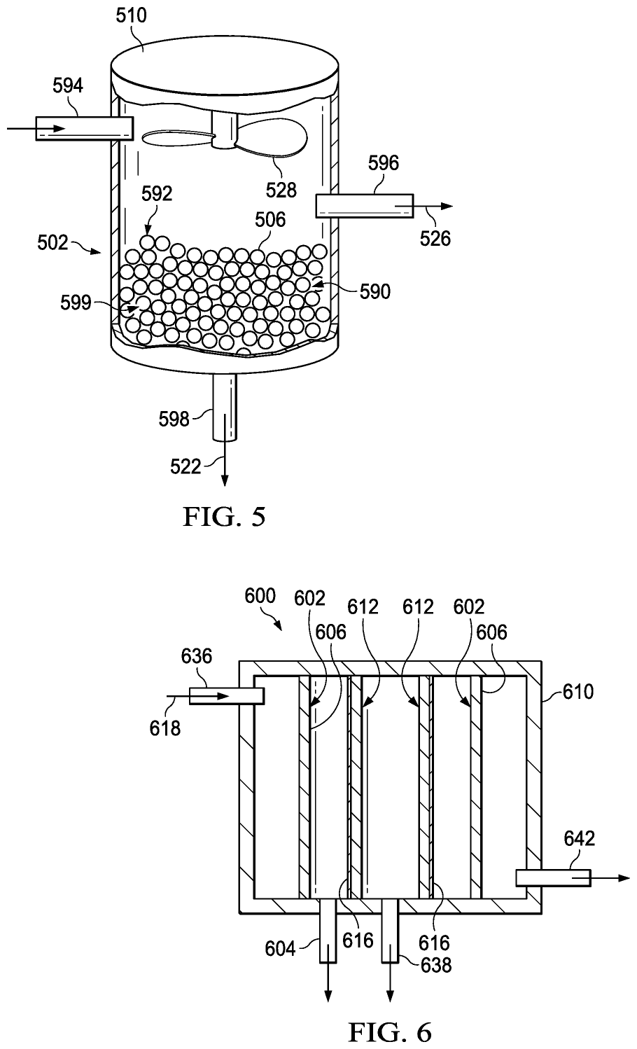

In an embodiment, the filtration medium may take the form of a sand pack filter device. FIG. 5 illustrates such an embodiment of the treatment unit 500. The filtration medium 502 may include a sand pack 590 formed by a collection of sand or other particulate 592 packed together. The sand pack 590 provides a porous structure in that the spaces between the particles 592 forming the sand pack 590 function as pores through which water can flow. The sand pack 590 may separate one side of the treatment unit 500 having the inlet 594 and second (retentate) outlet 596 from an opposite side of the treatment unit 500 having the first (permeate) outlet 598. The sand or other particulate 592 within the treatment unit 500 may function as the filtration medium substrate 599 onto which the zwitterionic polyelectrolyte 506 is coated. In some embodiments, an external surface of each sand particle 592 may be coated with a zwitterionic polyelectrolyte 506 to enhance the hydrophilic nature of the resulting sand pack filtration medium. In other embodiments, only an upper layer or portion of the sand particulate 592 within the sand pack 590 may be coated with a zwitterionic polyelectrolyte 506. The permeability of the sand pack filtration medium may be tailored by choosing a desired particle size distribution of the zwitterionic polyelectrolyte coated particulate. As illustrated, the treatment unit 500 of FIG. 5 may include a stirring or agitation device 528 on the fluid stream/retentate side of the filtration medium 502 to keep the boundary of the sand pack 590 refreshed.

The substrates used in any of the above types of filtration mediums may be constructed from, among other things, a polymer sheet, a ceramic material, a bundle of fibers, a sintered metal, a sand pack, or any combination thereof. In embodiments where the filtration medium includes one or more flat, cylindrical, or wrapped sheets, the sheet substrates may be constructed from a polymer material such as, for example, polyethylene, polypropylene, urethane, nylon, polyamide, polytetrafluoroethylene (PTFE), polyvinylidene fluoride (PVDF), polyvinylchloride (PVC), cellulose acetate, cellulose esters, polyimide, polyacrylonitrile (PAN), polyether sulfone (PES), polysulfone (PS), and any combination thereof. In embodiments where the filtration medium includes a porous material having tubular shaped pathways formed therethrough, the porous substrate may include a ceramic material such as, for example, alumina, titanic, zirconia oxides, silicon carbide, glass, and any combination thereof. In embodiments wherein the filtration medium includes a bundle of fibers, each fiber substrate may include one or more sintered metals such as, for example, aluminum, titanium, stainless steel, bronze, copper, and any combination thereof. In embodiments where the filtration medium takes the form of a sand pack filter device, the sand pack may be formed by a collection of sand or other particulates packed together such as, for example, quartz sand, garnet sand, glass beads, and aluminum oxide grit.

In each of the embodiments of FIGS. 1-5, the porous substrate of the filtration medium may have a pore size corresponding to the size of one or more open cells or spaces formed in the porous substrate. In some embodiments, the open cells or spaces in the porous substrate may have roughly the same pore size throughout. In other embodiments, the pore sizes of the open cells or spaces in the porous substrate may be varied. In certain embodiments, the porous substrate may have a pore size of less than about 10 micron, or alternatively less than about 5 micron, or alternatively, less than about 1 micron. In some embodiments the pore sizes within the porous substrate of the filtration medium may have a multi-modal distribution, where certain cells or spaces have a first smaller pore size and other cells or spaces have a second larger pore size.

In the following figures (FIGS. 6-8) of this application, the treatment unit is generally illustrated as having a cylindrical substrate (as shown in FIG. 2). However, it should be understood that any of the above embodiments of the treatment unit (as described with reference to FIGS. 1-5) may be used as well.

FIG. 6 illustrates an embodiment of the treatment unit 600 having a housing 610 and within the housing 610 includes a second filtration medium 612 in addition to the filtration medium 602 coated with a zwitterionic polyelectrolyte 606. In some embodiments, the second filtration medium 612 may be disposed within the treatment unit 600. In some embodiments, the second filtration medium 612 may be disposed upstream of the filtration medium 602 so that an input fluid stream 618 contacts with the second filtration medium 612 prior to contacting the filtration medium 602. In some embodiments, the second filtration medium 612 may be coated with a material 616, such as graphene oxide, to separate salts from an input fluid stream 618 containing water-entrenched brine. Including both the zwitterionic polyelectrolyte coated filtration medium 602 and the graphene oxide coated second filtration medium 612 within the same treatment unit 600 enables the treatment unit 600 to produce a salt, water, and solids separation without using mechanical action. For example, the zwitterionic polyelectrolyte coated filtration medium 602 may separate the oil and/or solids from the water-entrenched brine, and the second filtration medium 612 may separate the water from the brine. The zwitterionic polyelectrolyte coated filtration medium 602 may allow the water entrenched brine to pass through the zwitterionic polyelectrolyte coated filtration medium 602, and the separated solids and/or oil may be output via outlet 642. The second filtration medium 612 may separate the water from the brine, outputting the water through outlet 638 and the higher density brine through outlet 604. This treatment unit 600 may be used as a passive polishing unit for brine reclamation by separating both water and oil from a brine.

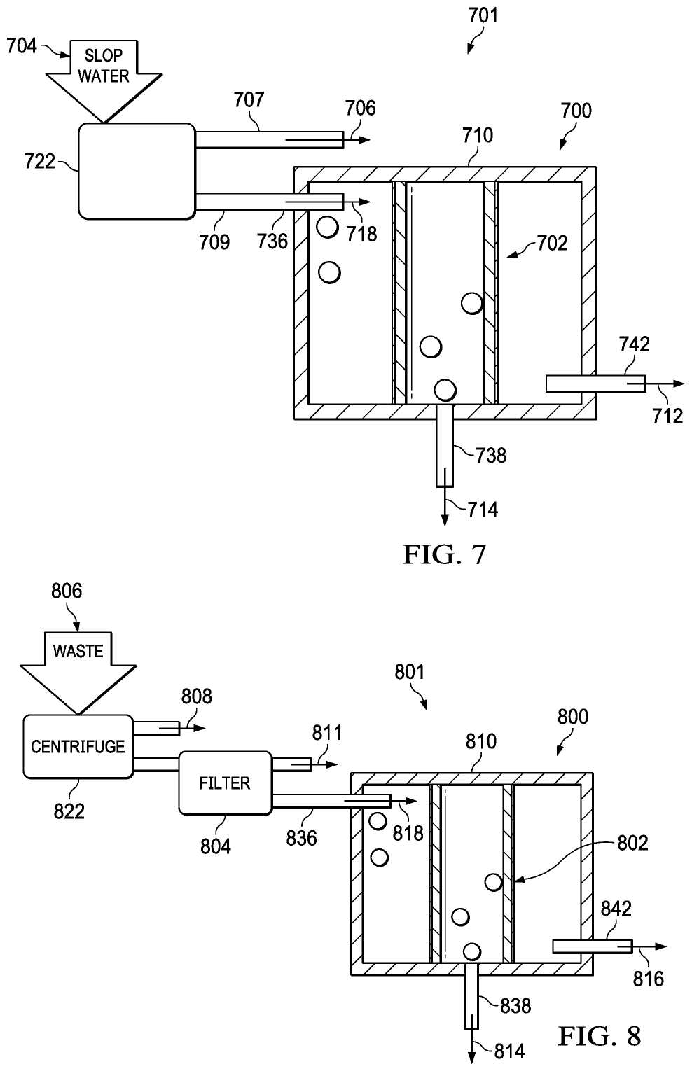

FIGS. 7 and 8 illustrate two embodiments of slop water treatment systems 701 and 801, respectively, in accordance with the present disclosure. Both treatment systems 701 and 801 include one or more pretreatment units used to pretreat the slop water recovered from the rig before the fluid is transferred to the treatment units 700 and 800, respectively, for separation of clean water from its contaminants. Although certain pretreatment processes are shown in FIGS. 7 and 8, any desired combination of one or more pretreatment processes (e.g., centrifugation, filtering, dissolved air flotation, UV, chemical such as oxidizers, enzymes, electrophoretic methods, etc.) may be performed using one or more pretreatment units to initially condition the slop water.

In FIG. 7, the slop water treatment system 701 may include, among other things, a dissolved air flotation (DAF) unit 722 and the treatment unit 700. The DAF unit 722 may include a slop treatment unit such as BARAH2O™ (slop treatment unit, available from Halliburton Energy Services, Inc.). The DAF unit 722 may be modular and configured for treating oily water slop produced on an offshore rig. The DAF unit 722 and treatment unit 700 may both be located at the offshore rig site. The DAF unit 722 may utilize a combination of chemical treatment and DAF to treat incoming slop water 704 and output oils and solids 706 via a first outlet 707 separate from contaminated water in a second outlet 709. The contaminated water may be provided as the input fluid stream 718 to the inlet 736 of the treatment unit 700. The treatment unit 700 may have a housing 710 and a zwitterionic polyelectrolyte coated filtration medium 702 disposed in the housing 710. In some embodiments, the treatment unit 700 may further separate clean water 714 from leftover contaminants 712 such as oils. The clean water 714 may be output through the first outlet 738 while the contaminants 712 are output from the second outlet 742. In certain embodiments, the clean water 714 output from the treatment unit 700 may be potable. In some embodiments, the disclosed methods may include reusing the clean water 714 output from the filtration medium or disposing of the clean water 714 at the offshore rig. In some embodiments, using the treatment unit 700 of FIG. 7, the effectiveness of the DAF unit 722 may be enhanced via the additional water treatment using the zwitterionic polyelectrolyte coated treatment unit 702. As such, the zwitterionic polyelectrolyte coated treatment unit 702 may reduce hydrocarbon content in the water.

In FIG. 8, the slop water treatment system 801 may include, among other things, a centrifuge 822, a solids filter 804, and the treatment unit 800. The centrifuge 822, filter 804, and treatment unit 800 may all be located at the offshore rig site. The centrifuge 822 may treat incoming slop water 806 to separate out oils 808. Then the remaining fluid stream may be received at the filter 804 and filtered to separate solids 811 from contaminated water. The contaminated water may be provided as the input fluid stream 818 to the inlet 836 of the treatment unit 800. The treatment unit 800 may have a housing 810 and a zwitterionic polyelectrolyte coated filtration medium 802 disposed in the housing 810. In some embodiments, the treatment unit 800 may further separate clean water 814 from leftover contaminants 816 such as oils. The clean water 814 may be output through the first outlet 838 while the contaminants 816 are output from the second outlet 842. In some embodiments, the clean water 814 output from the treatment unit 800 may be potable. Using the slop water treatment system 801 of FIG. 8, the zwitterionic polyelectrolyte coated filtration medium 802 may reduce hydrocarbon content in the water. Disclosed methods may include reusing the clean water 814 output from the filtration medium or disposing of the clean water 814 at the offshore rig.

The fluids recovered from the well and treated using the methods and systems of the present disclosure may include any aqueous base fluid known in the art. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may include water from any source. Such aqueous fluids may include fresh water, salt water (e.g., water containing one or more salts dissolved therein), brine (e.g., saturated salt water), seawater, or any combination thereof. In most embodiments of the present disclosure, the aqueous fluids include one or more ionic species, such as those formed by salts dissolved in water. For example, seawater and/or produced water may include a variety of divalent cationic species dissolved therein. In certain embodiments, the density of the aqueous fluid can be adjusted, among other purposes, to provide additional particulate transport and suspension as desired. In certain embodiments, the pH of the aqueous fluid may be adjusted (e.g., by a buffer or other pH adjusting agent) to a specific level, which may depend on, among other factors, the types of additives included in the fluid.

In certain embodiments, the fluids recovered from the well and treated using the methods and systems of the present disclosure optionally may include any number of additional additives. Examples of such additional additives include, but are not limited to, salts, surfactants, acids, proppant particulates, diverting agents, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, H₂S scavengers, CO₂ scavengers, oxygen scavengers, lubricants, viscosifiers, breakers, weighting agents, relative permeability modifiers, resins, wetting agents, coating enhancement agents, filter cake removal agents, antifreeze agents (e.g., ethylene glycol), cross-linking agents, curing agents, gel time moderating agents, curing activators, and the like. In some embodiments, the fluid may contain rheology (viscosity and gel strength) modifiers and stabilizers.

The present disclosure in some embodiments provides methods for treating aqueous fluids that are recovered from the well after carrying out a variety of subterranean treatments, including but not limited to, drilling operations, completion operations, hydraulic fracturing treatments, and acidizing treatments. In some embodiments, the methods of the present disclosure may include recovering at least a portion of the treatment fluid from the well and treating the recovered fluid using one or more fluid treatment operations. In the present disclosure, at least one of the fluid treatment operations includes separating water from another portion of the treatment fluid using a zwitterionic polyelectrolyte coated filtration medium. In some embodiments, the fluid treatment operations include one or more pretreatment operations performed by one or more pretreatment units on the treatment fluid before the water separation using a zwitterionic polyelectrolyte coated filtration medium. The pretreatment operations may include, among other things, one or more processes of centrifugation, solids filtering, dissolved air flotation, UV operations, application of chemicals such as oxidizers, application of enzymes, and electrophoretic methods, among others. The fluid pretreatment unit(s) may include, but are not limited to, one or more of a shaker (e.g., shale shaker), a centrifuge, a hydrocyclone, a separator (including magnetic and electrical separators), a DAF unit, a desilter, a desander, a separator, a filter (e.g., diatomaceous earth filters), a heat exchanger, fluid reclamation equipment, and the like. The fluid pretreatment unit(s) may further include one or more sensors, gauges, pumps, compressors, and the like used to store, monitor, regulate, and/or recondition the fluids.

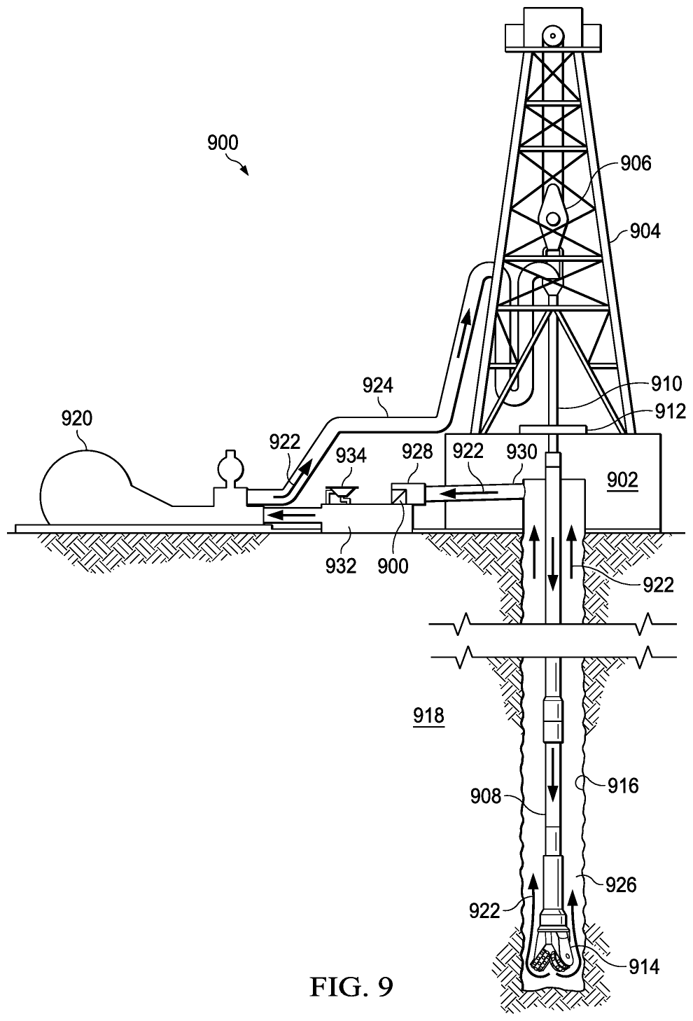

The fluid treatment systems and methods of the present disclosure may directly or indirectly affect one or more components or pieces of equipment associated with the preparation, delivery, recapture, recycling, reuse, and/or disposal of the treatment fluids of the present disclosure. For example, the fluid treatment systems and methods may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the fluids treated by the present disclosure. The fluid treatment systems and methods of the present disclosure may also directly or indirectly affect any transport or delivery equipment used to convey the treated fluid to or from a well site or downhole such as, for example, any transport vessels, conduits, pipelines, trucks, tubulars, and/or pipes used to move fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, and/or combinations thereof, and the like. For example, and with reference to FIG. 9, the disclosed fluid treatment systems and methods may directly or indirectly affect one or more components or pieces of equipment associated with an example of a wellbore drilling assembly 900, according to one or more embodiments. It should be noted that while FIG. 9 generally depicts a land-based drilling assembly, those skilled in the art will readily recognize that the principles described herein are equally applicable to subsea drilling operations that employ floating or sea-based platforms and rigs (particularly for treating slop water offshore) without departing from the scope of the disclosure. It should also be noted that while FIG. 9 generally depicts a drilling operation, those skilled in the art will readily recognize that the disclosed fluid treatment systems and methods may be similarly applied during completion and stimulation operations.

As illustrated, the drilling assembly 900 may include a drilling platform 902 that supports a derrick 904 having a traveling block 906 for raising and lowering a drill string 908. The drill string 908 may include, but is not limited to, drill pipe and coiled tubing, as generally known to those skilled in the art. A kelly 910 supports the drill string 908 as it is lowered through a rotary table 912. A drill bit 914 is attached to the distal end of the drill string 908 and is driven either by a downhole motor and/or via rotation of the drill string 908 from the well surface. As the bit 914 rotates, it creates a borehole 916 that penetrates various subterranean formations 918.

A pump 920 (e.g., a mud pump) circulates drilling fluid 922 through a feed pipe 924 and to the kelly 910, which conveys the drilling fluid 922 downhole through the interior of the drill string 908 and through one or more orifices in the drill bit 914. The drilling fluid 922 is then circulated back to the surface via an annulus 926 defined between the drill string 908 and the walls of the borehole 916. At the surface, the recirculated or spent drilling fluid 922 exits the annulus 926 and may be conveyed to one or more fluid processing unit(s) 928 via an interconnecting flow line 930. The one or more fluid processing unit(s) 928 may include one or more pretreatment units and the treatment unit of the present disclosure. After passing through the fluid processing unit(s) 928, a “cleaned” drilling fluid 922 is deposited into a nearby retention pit 932 (i.e., a mud pit). This cleaned drilling fluid 922 may include, for example, a higher percentage of water than drilling fluid that is cleaned without the zwitterionic polyelectrolyte coated treatment unit. While illustrated as being arranged at the outlet of the wellbore 916 via the annulus 926, those skilled in the art will readily appreciate that the fluid processing unit(s) 928 may be arranged at any other location in the drilling assembly 900 to facilitate its proper function, without departing from the scope of the disclosure. In certain embodiments, such as those using fluid processing unit(s) 928 to condition brine-based completion fluids, certain fluid processing unit(s) 928 may be located at a mud plant remote from the well location.

One or more additives may be added to the drilling fluid 922 via a mixing hopper 934 communicably coupled to or otherwise in fluid communication with the retention pit 932. The mixing hopper 934 may include, but is not limited to, mixers and related mixing equipment known to those skilled in the art. In other embodiments, however, additives may be added to the drilling fluid 922 at any other location in the drilling assembly 900. In at least one embodiment, for example, there could be more than one retention pit 932, such as multiple retention pits 932 in series. Moreover, the retention pit 932 may be representative of one or more fluid storage facilities and/or units where recovered well fluids may be stored, reconditioned, and/or regulated until added to the drilling fluid 922.

As mentioned above, the disclosed fluid treatment systems and methods may directly or indirectly affect the components and equipment of the drilling assembly 900 by efficiently separating water from recovered well fluids. For example, the treated well fluids may directly or indirectly affect one or more components of the fluid processing unit(s) 928 including, but not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, additional fluid reclamation equipment, and the like.

The disclosed fluid treatment systems and methods may directly or indirectly affect the pump 920, which representatively includes any conduits, pipelines, trucks, tubulars, and/or pipes used to fluidically convey recycled well fluids downhole, any pumps, compressors, or motors (e.g., topside or downhole) used to drive the treated fluids into motion, any valves or related joints used to regulate the pressure or flow rate of the treated fluids, and any sensors (i.e., pressure, temperature, flow rate, etc.), gauges, and/or combinations thereof, and the like. The disclosed fluid treatment systems and methods may also directly or indirectly affect the mixing hopper 934 and the retention pit 932 and their assorted variations.

The disclosed fluid treatment systems and methods may also directly or indirectly affect various downhole equipment and tools that may come into contact with recycled or reconditioned fluids such as, but not limited to, the drill string 908, any floats, drill collars, mud motors, downhole motors and/or pumps associated with the drill string 908, and any MWD/LWD tools and related telemetry equipment, sensors or distributed sensors associated with the drill string 908. The disclosed fluid treatment systems and methods may also directly or indirectly affect any downhole heat exchangers, valves and corresponding actuation devices, tool seals, packers and other wellbore isolation devices or components, and the like associated with the wellbore 916. The disclosed fluid treatment systems and methods may also directly or indirectly affect the drill bit 914, which may include, but is not limited to, roller cone bits, PDC bits, natural diamond bits, hole openers, reamers, coring bits, electrocrush bits, etc.

While not specifically illustrated herein, the disclosed fluid treatment systems and methods may also directly or indirectly affect transport or delivery equipment used to convey the treated fluids to or from the drilling assembly 900 such as, for example, any transport vessels, conduits, pipelines, trucks, tubulars, and/or pipes used to fluidically move the fluids from one location to another, any pumps, compressors, or motors used to drive the treated fluids into motion, any valves or related joints used to regulate the pressure or flow rate of the treated fluids, and any sensors (i.e., pressure and temperature), gauges, and/or combinations thereof, and the like. The disclosed fluid treatment systems and methods may also directly or indirectly affect disposal equipment used to dispose of the treated fluids at the well location, including equipment for releasing or pumping clean water into the environment.

An embodiment of the present disclosure is a fluid treatment system for treating slop water, wherein the fluid treatment system includes: a treatment unit including an inlet for receiving a slop water stream into the treatment unit, a first filtration medium including a porous substrate at least partially coated with a zwitterionic polyelectrolyte, wherein the first filtration medium is disposed to separate first portion of the slop water stream in the treatment unit from a second portion of the slop water stream in the treatment unit, wherein the first portion of the slop water stream includes water, a first outlet on a first side of the first filtration medium, and a second outlet on a second side of the first filtration medium opposite the first side.

In one or more embodiments described in the preceding paragraph, the zwitterionic polyelectrolyte includes at least one zwitterionic polyelectrolyte selected from the group consisting of poly(2-methacryloyloxyethyl phosphorylcholine) (PMPC), poly(sulfobetaine methacrylate) (PSBMA), poly(sulfobetaineacrylamide) (PSBAAm), poly(carboxybetaine methacrylate) (PCBMA), poly(carboxybetaine acrylamide) (PCBAA), poly[oligo(ethyleneglycol) methacrylate] (POEGMA), poly (3-(1-(4-vinylbenzyl)-1H-imidazol-3-ium-3-yl)propane-1-sulfonate) (PVBIPS), and any combination thereof. In one or more embodiments described in the preceding paragraph, the zwitterionic polyelectrolyte is poly(2-methacryloyloxyethyl phosphorylcholine) (PMPC). In one or more embodiments described in the preceding paragraph, the treatment unit is configured to maintain a pressure differential of about 1 psi to about 25 psi across the filtration medium. In one or more embodiments described in the preceding paragraph, the treatment unit further includes a second filtration medium within the treatment unit. In one or more embodiments described in the preceding paragraph, the second filtration medium includes a porous substrate at least partially coated with a graphene oxide. In one or more embodiments described in the preceding paragraph, the porous substrate includes at least one material selected from the group consisting of a sintered metal, a ceramic material, a polymer sheet, a bundle of fibers, a sand pack, and any combination thereof. In one or more embodiments described in the preceding paragraph, the fluid treatment system further includes at least one pretreatment component including one or more of a centrifuge and a solids filter disposed upstream of the treatment unit, the at least one pretreatment component receives the slop water and outputs a pretreated slop water stream to the treatment unit. In one or more embodiments described in the preceding paragraph, the at least one pretreatment component includes a dissolved air flotation (DAF) unit. In one or more embodiments described in the preceding paragraph, the treatment unit further includes a stirring or agitation device.

An embodiment of the present disclosure is a method for treating slop water recovered from wellbore operations that includes: receiving a slop water stream in a treatment unit via an inlet of the treatment unit; contacting the slop water stream with a first filtration medium of the treatment unit, the first filtration medium including a porous substrate at least partially coated with zwitterionic polyelectrolyte; separating a first portion of the slop water stream from a second portion of the slop water stream via the first filtration medium, wherein the first portion of the slop water stream includes water; outputting the first portion of the slop water stream via a first outlet of the treatment unit; and outputting the second portion of the slop water stream via a second outlet of the treatment unit.

In one or more embodiments described in the preceding paragraph, further including performing a pretreatment step on the slop water stream, wherein the pretreatment step includes receiving a quantity of slop water recovered from a well; pretreating the slop water recovered from the well using the at least one pretreatment unit to form a pretreated slop water stream; and discharging the pretreated slop water stream into the treatment unit. In one or more embodiments described in the preceding paragraph, the zwitterionic polyelectrolyte includes at least one zwitterionic polyelectrolyte selected from the group consisting of poly(2-methacryloyloxyethyl phosphorylcholine) (PMPC), poly(sulfobetaine methacrylate) (PSBMA), poly(sulfobetaineacrylamide) (PSBAAm), poly(carboxybetaine methacrylate) (PCBMA), poly(carboxybetaine acrylamide) (PCBAA), poly[oligo(ethyleneglycol) methacrylate] (POEGMA), poly (3-(1-(4-vinylbenzyl)-1H-imidazol-3-ium-3-yl)propane-1-sulfonate) (PVBIPS), and any combination thereof. In one or more embodiments described in the preceding paragraph, further including providing self-cleaning of the first filtration medium, and displacing oil contamination on the first filtration medium in a dry state upon contact with water. In one or more embodiments described in the preceding paragraph, the treatment unit is configured to maintain a pressure differential of about 1 psi to about 25 psi across the filtration medium. In one or more embodiments described in the preceding paragraph, the porous substrate includes a material construction selected from the group consisting of a sintered metal, a ceramic material, a polymer sheet, a bundle of fibers, a sand pack, and any combination thereof. In one or more embodiments described in the preceding paragraph, further including separating a third portion of the slop water stream from the first and second portions of the slop water stream via a second filtration medium within the treatment unit, wherein the second filtration medium separates salts from the slop water stream, wherein the second portion includes oil and the third portion includes salt. In one or more embodiments described in the preceding paragraph, pretreating the slop water includes removing oil and solid waste from the slop water stream via a centrifuge, a solids filter, or both. In one or more embodiments described in the preceding paragraph, pretreating the slop water includes removing oil and solid waste from the slop water stream via a dissolved air flotation (DAF) unit. In one or more embodiments described in the preceding paragraph, the treatment unit further includes a stirring or agitation device.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A fluid treatment system for treating slop water, the fluid treatment system comprising:
a treatment unit, comprising:
an inlet for receiving a slop water stream into the treatment unit;
a first filtration medium comprising a particulate pack at least partially coated with a zwitterionic polyelectrolyte, wherein the first filtration medium is disposed to separate a first portion of the slop water stream in the treatment unit from a second portion of the slop water stream in the treatment unit, wherein the first portion of the slop water stream comprises water;
a first outlet on a first side of the first filtration medium; and
a second outlet on a second side of the first filtration medium opposite the first side.

2. The fluid treatment system of claim 1, wherein the zwitterionic polyelectrolyte comprises at least one zwitterionic polyelectrolyte selected from the group consisting of poly(2-methacryloyloxyethyl phosphorylcholine) (PMPC), poly(sulfobetaine methacrylate) (PSBMA), poly(sulfobetaineacrylamide) (PSBAAm), poly(carboxybetaine methacrylate) (PCBMA), poly(carboxybetaine acrylamide) (PCBAA), poly[oligo(ethyleneglycol) methacrylate] (POEGMA), poly (3-(1-(4-vinylbenzyl)-1H-imidazol-3-ium-3-yl)propane-1-sulfonate) (PVBIPS), and any combination thereof.

3. The fluid treatment system of claim 1, wherein the zwitterionic polyelectrolyte is poly(2-methacryloyloxyethyl phosphorylcholine) (PMPC).

4. The fluid treatment system of claim 1, wherein the treatment unit is configured to maintain a pressure differential of about 1 psi to about 25 psi across the filtration medium.

5. The fluid treatment system of claim 1, wherein the treatment unit further comprises a second filtration medium within the treatment unit.

6. The fluid treatment system of claim 5, wherein the second filtration medium comprises a porous substrate at least partially coated with a graphene oxide.

7. The fluid treatment system of claim 1, wherein the particulate pack comprises a material selected from the group consisting of a metal, a ceramic material, a sand, and any combination thereof.

8. The fluid treatment system of claim 1, further comprising at least one pretreatment component comprising:
an inlet configured to receive slop water into the pretreatment component;
an outlet connected to the inlet of the treatment unit unit; and
one or more of a centrifuge and a solids filter.

9. The fluid treatment system of claim 8, wherein the at least one pretreatment component comprises a dissolved air flotation (DAF) unit.

10. The fluid treatment system of claim 1, wherein the treatment unit further comprises a stirring or agitation device.

11. A method for treating slop water recovered from wellbore operations, comprising:
receiving a slop water stream in a treatment unit via an inlet of the treatment unit;
contacting the slop water stream with a first filtration medium of the treatment unit, the first filtration medium comprising a particulate pack at least partially coated with a zwitterionic polyelectrolyte;
separating a first portion of the slop water stream from a second portion of the slop water stream via the first filtration medium, wherein the first portion of the slop water stream comprises water;
discharging the first portion of the slop water stream via a first outlet of the treatment unit; and
discharging the second portion of the slop water stream via a second outlet of the treatment unit.

12. The method of claim 11 further comprising performing a pretreatment step on the slop water stream, wherein the pretreatment step comprises:
receiving a quantity of slop water recovered from a well;
pretreating the slop water recovered from the well using at least one pretreatment unit to form a pretreated slop water stream; and
discharging the pretreated slop water stream into the treatment unit.

13. The method of claim 11, wherein the zwitterionic polyelectrolyte comprises at least one zwitterionic polyelectrolyte selected from the group consisting of poly(2-methacryloyloxyethyl phosphorylcholine) (PMPC), poly(sulfobetaine methacrylate) (PSBMA), poly(sulfobetaineacrylamide) (PSBAAm), poly(carboxybetaine methacrylate) (PCBMA), poly(carboxybetaine acrylamide) (PCBAA), poly[oligo(ethyleneglycol) methacrylate] (POEGMA), poly (3-(1-(4-vinylbenzyl)-1H-imidazol-3-ium-3-yl)propane-1-sulfonate) (PVBIPS), and any combination thereof.

14. The method of claim 11, further comprising:
providing self-cleaning of the first filtration medium; and
displacing oil contamination on the first filtration medium in a dry state upon contact with water.

15. The method of claim 11, wherein the treatment unit is configured to maintain a pressure differential of about 1 psi to about 25 psi across the filtration medium.

16. The method of claim 11, wherein the particulate pack comprises a material selected from the group consisting of a metal, a ceramic material, a sand, and any combination thereof.

17. The method of claim 11, further comprising:
separating a third portion of the slop water stream from the first and second portions of the slop water stream via a second filtration medium within the treatment unit, wherein the second filtration medium separates salts from the slop water stream, wherein the second portion comprises oil and the third portion comprises salt.

18. The method of claim 12, wherein pretreating the slop water comprises removing oil and solid waste from the slop water stream via a centrifuge, a solids filter, or both.

19. The method of claim 12, wherein pretreating the slop water comprises removing oil and solid waste from the slop water stream via a dissolved air flotation (DAF) unit.

20. The method of claim 11, wherein the treatment unit further comprises a stirring or agitation device.
